(19) United States
(12) Patent Application Publication
(10) Pub. No.: US 2025/0245516 A1
(43) Pub. Date: Jul. 31, 2025

(54) SYSTEMS AND METHODS FOR FOUNDATION MODELS BASED REWARD DESIGN FOR AUTONOMOUS DRIVING

(71) Applicant: Robert Bosch GmbH, Stuttgart (DE)

(72) Inventors: Feng TAO, Cupertino, CA (US); Xin YE, San Jose, CA (US); Burhaneddin YAMAN, San Jose, CA (US); Tommaso NESTI, Mountain View, CA (US); Abhirup MALLIK, San Jose, CA (US); Liu REN, Saratoga, CA (US)

(21) Appl. No.: 18/428,515

(22) Filed: Jan. 31, 2024

(51) Int. Cl. G06N 3/092

(52) U.S. Cl. CPC G06N 3/092

(57) ABSTRACT

Methods and systems for optimizing an action policy of an autonomous vehicle machine learning model. Images are generated corresponding to an environment about a vehicle. These images are passed through an image encoder to generate image-based embeddings of the current state of the vehicle. A text prompt representing a goal of the autonomous vehicle is passed through a text encoder to generate text-based embeddings of the goal. A similarity score is determined, representing a similarity between the image-based embeddings of the current state and the text-based embeddings of the goal. A reinforcement learning model for a closed-loop autonomous driving task is executed, with the similarity score used as the reward function. An action policy corresponding to a control of the vehicle is optimized based on the reward function.

### TECHNICAL FIELD

The present disclosure relates to systems and methods for foundation models based reward designs for autonomous driving. In embodiments, foundation models are utilized to output a similarity score which is used as a reward in a reinforcement learning model used for autonomous driving training.

### BACKGROUND

An autonomous vehicle, often referred to as a self-driving or driverless vehicle, is a type of vehicle capable of navigating and operating on roads and in various environments without direct human control. Autonomous vehicles use a combination of advanced technologies and sensors to perceive their surroundings, make decisions, and execute driving tasks.

Autonomous vehicles are typically equipped with a variety of sensors, including lidar, radar, cameras, ultrasonic sensors, and sometimes additional technologies like GPS and IMUs (Inertial Measurement Units). These sensors provide real-time data about the vehicle's surroundings, including the positions of other vehicles, pedestrians, road signs, and road conditions. The vehicle's onboard computers use data from sensors to create a detailed map of the environment and to perceive objects and obstacles. This information is essential for navigation and collision avoidance.

Reinforcement learning (RL) can be used with autonomous driving, where models learn optimal decision-making by interacting with the environment. Trained on sensor data, RL agents create a state representation, define an action space, and learn a policy mapping states to actions. Through simulation training and continuous learning, RL models adapt to diverse driving scenarios. Integration with perception systems enhances the vehicle's ability to navigate safely.

### SUMMARY

According to an embodiment, a method for optimizing an action policy of a machine learning model of an autonomous vehicle includes the following: generating an image of an environment about an autonomous vehicle based on vehicle sensor data representing a current state of the autonomous vehicle; passing the generated image through an image encoder to generate image-based embeddings of the current state of the autonomous vehicle; receiving a text prompt representing a goal of the autonomous vehicle; passing the text prompt through a text encoder to generate text-based embeddings of the goal; determining a similarity score representing a similarity between the image-based embeddings of the current state and the text-based embeddings of the goal; executing a reinforcement learning model for a closed-loop autonomous driving task, wherein the similarity score is utilized as a reward in the reinforcement learning model; and optimizing an action policy of the reinforcement learning model based on the similarity score utilized as the reward, wherein the action policy is associated with a control command of the autonomous vehicle.

In another embodiment, a system for optimizing an action policy of a machine learning model of an autonomous vehicle is provided. The system includes one or more image sensors mounted to an autonomous vehicle and configured to generate images external to the autonomous vehicle representing a current state of the autonomous vehicle. The system includes one or more processors communicatively coupled to the one or more images sensors. The one or more sensors are programmed to perform the following: receive the generated images from the one or more image sensors, execute an image encoder on the generated images to generate image-based embeddings of the current state of the vehicle, receive a text prompt representing a goal of the autonomous vehicle, execute a text encoder on the text prompt to generate text-based embeddings of the goal, determine a similarity score representing a similarity between the image-based embeddings of the current state and the text-based embeddings of the goal, execute a reinforcement learning model for a closed-loop autonomous driving task, wherein the similarity score is utilized as a reward in the reinforcement learning model, and optimize an action policy of the reinforcement learning model based on the similarity score utilized as the reward, wherein the action policy is associated with a control command of the autonomous vehicle.

In another embodiment, a non-volatile computer-readable storage medium stores instructions that, when executed by one or more processor, cause the processor to perform any or all of the above steps.

### BRIEF DESCRIPTION OF THE DRAWINGS

FIG. 1 shows a system for training a neural network, according to an embodiment.

FIG. 2 shows a computer-implemented method for training and utilizing a neural network, according to an embodiment.

FIG. 3 shows a schematic diagram of a control system configured to control a vehicle, which may be a partially autonomous vehicle, a fully autonomous vehicle, a partially autonomous robot, or a fully autonomous robot, according to an embodiment.

FIG. 4 illustrates a schematic diagram of a foundation model augmented goal-orientated reinforcement learning system, according to an embedment in which an output of a foundation model similarity score is used as a reward for reinforcement learning.

FIG. 5 illustrates a schematic diagram of the use of a foundation model (e.g., vision-language model) within a reinforcement learning model scheme, according to an embodiment.

FIG. 6 illustrates a schematic of a contrastive learning model according to an embodiment.

FIG. 7 illustrates a method for optimizing an action policy of a machine learning model of an autonomous vehicle, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

In the context of autonomous vehicles and machine learning (e.g., reinforcement learning), the terms “agent,” “state,” and “environment” are used. The term “agent” can refer to the entity that makes the decision and takes action within an environment. This can include the autonomous vehicle itself, specifically its computing systems that performs the decision making. The “environment” represents the external system or surroundings with which the agent interacts. It includes things that the agent does not control but can perceive and affect through its actions. In autonomous driving, the environment can include the road, other vehicles, pedestrians, traffic signals, and any other relevant factors. The agent receives feedback and rewards from the environment based on its actions. The “state” is a representation of the current situation or configuration of the environment that the agent observes. It contains relevant information needed for the agent to make decisions. In the context of autonomous driving, the state can include the positions and velocities of nearby vehicles, the current location of the autonomous vehicle, traffic conditions, and other relevant details. In the context of an autonomous vehicle navigating through traffic, the agent (autonomous vehicle) continually perceives the state of the environment (traffic conditions, positions of other vehicles, etc.), decides on actions (such as steering, acceleration, and braking), and receives feedback from the environment in the form of rewards or penalties based on the consequences of its actions. Reinforcement learning in this context allows the agent to learn a policy that maximizes the cumulative reward over time, leading to safe and efficient driving behavior.

Reinforcement learning seeks the optimal policies for sequential decision-making processes, which makes it an ideal tool for solving closed-loop tasks in the autonomous driving field. The main challenge in effectively implementing reinforcement learning algorithms lies in the intricate task of crafting a dense and well-shaped reward function. A sparse reward function that encourages the completion of a task or discourages failures is easy to specify, but it works only for simple tasks such as highway lane following. When facing complex driving scenarios, the learning agent will stuck at local optimums as the sparse reward function does not motivate exploration and consequently the learned action policy/strategy is suboptimal. To resolve this issue and define a good reward function, previous work mostly focus on hand-engineering a reward function based on the traffic rules. The hand-engineering approach deliberates a good reward function that works well for individual tasks, say, parking, highway driving, etc. However, it requires extensive expert knowledge to define the reward function so that the learning agent would not hack the reward without learning how to perform the tasks. Moreover, such reward function lacks generalizability across diverse tasks. Hence, an easy and general reward design technique is a necessity for non-expert users.

Recent development on foundation models offers a brand-new direction for designing the reward function required in reinforcement learning. However, so far there are no existing work that applies foundation models in the reward design for autonomous driving. This is due to several reasons. For example, the current industry research emphasis is mainly on open-loop tasks. Also, simulators like CARLA provide all necessary ground-truth information, which commonly leads to the hand-engineering reward design. Since foundation models can provide an easy and general reward design technique, it has the potential to be a promising and popular research area for solving closed-loop autonomous driving tasks.

This disclosure presents novel approaches for using foundation models for the reward function definition process in autonomous driving. According to embodiments, the foundation models are first leveraged to get visual state observations and goal state embeddings. Then, the cosine distance between these two embeddings is determined as the reward value. Note in embodiments, the cosine distance is used here instead of cosine similarity, which gives the capability of capturing abstract linguistic concept

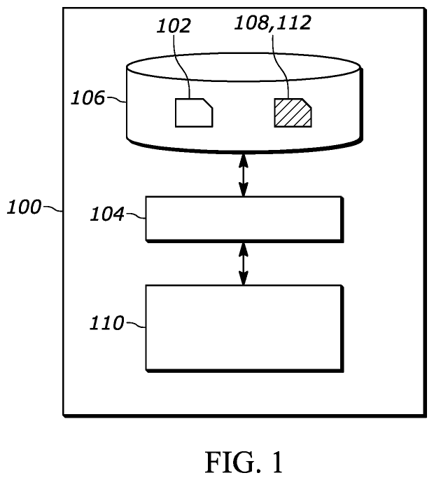

Machine learning and neural networks are an integral part of the inventions disclosed herein. FIG. 1 shows a system 100 for training a neural network, e.g. a deep neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106.

The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive, as input, an output of a previous layer, or for a first layer of the stack of layers, an initial activation and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network; this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may, during or after the training, be replaced at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

The system 100 shown in FIG. 1 is one example of a system that may be utilized to train the machine learning models described herein.

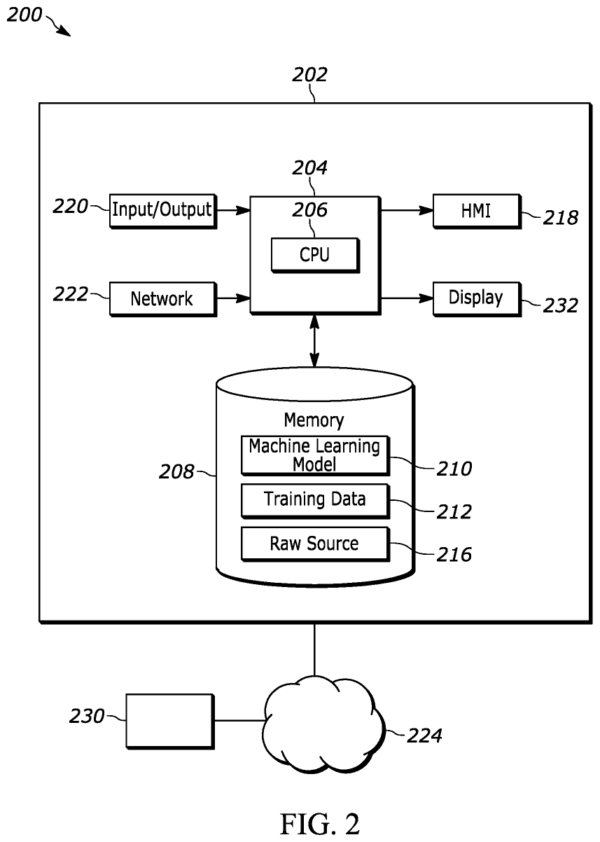

FIG. 2 depicts a system 200 to implement the machine-learning models described herein, for example the foundation models and reinforcement learning models with foundation-model based rewards. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuitry or BUS networks to transfer information to or between the processor(s) and storage. For example, the I/O interface 220 can include digital I/O logic lines which can be read or set by the processor(s), handshake lines to supervise data transfer via the I/O lines, timing and counting facilities, and other structure known to provide such functions. Examples of input devices include a keyboard, mouse, sensors, touch screen, etc. Examples of output devices include monitors, touchscreens, speakers, head-up displays, vehicle control systems, etc. The I/O interface 220 may include additional serial interfaces for communicating with external devices (e.g., Universal Serial Bus (USB) interface). The I/O interface 220 can be referred to as an input interface (in that it transfers data from an external input, such as a sensor), or an output interface (in that it transfers data to an external output, such as a display).

The computing system 202 may include a human-machine interface (HMI) device 218 that may include any device that enables the system 200 to receive control input. The computing system 202 may include a display device 232. The computing system 202 may include hardware and software for outputting graphics and text information to the display device 232. The display device 232 may include an electronic display screen, projector, speaker or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data (e.g., a pressure sensor signal over time), and raw or partially processed sensor data (e.g., radar map of objects). In some examples, the machine-learning algorithm 210 may be a neural network algorithm (e.g., deep neural network) that is designed to perform a predetermined function. For example, the neural network algorithm may be configured in automotive applications to identify street signs or pedestrians in images. The machine-learning algorithm(s) 210 may include algorithms configured to operate one or more of the machine learning models described herein, including the VLP Foundation model.

The computing system 202 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include input images that include an object (e.g., a street sign). The input images may include various scenarios in which the objects are identified. The training dataset 212 may also include the text description of the scene (e.g., “the pedestrian is crossing the street”) that corresponds to the images detected by the vehicle sensors.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data. In the context of the reinforcement learning model described herein, a comparison is made between the commanded action Aₜ of the autonomous vehicle and the reward based on the current state of the vehicle during or after the action is commanded, and the model can be trained with an optimizer to reduce this loss (e.g., increase the reward), which can lead to convergence.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to identify the presence of other objects (e.g., other cars, pedestrians, etc.) in video images, annotate the occurrences, and/or command the vehicle to take a specific action (planning) based on the locational data of the detected object (perception) and the predicted future movement/location of the object (prediction). The machine-learning algorithm 210 may be programmed to process the raw source data 216 to identify the presence of the particular features. The machine-learning algorithm 210 may be configured to identify a feature in the raw source data 216 as a predetermined feature (e.g., road sign, pedestrian, etc.). The raw source data 216 may be derived from a variety of sources. For example, the raw source data 216 may be actual input data collected by a machine-learning system. The raw source data 216 may be machine generated for testing the system. As an example, the raw source data 216 may include raw video images from a camera.

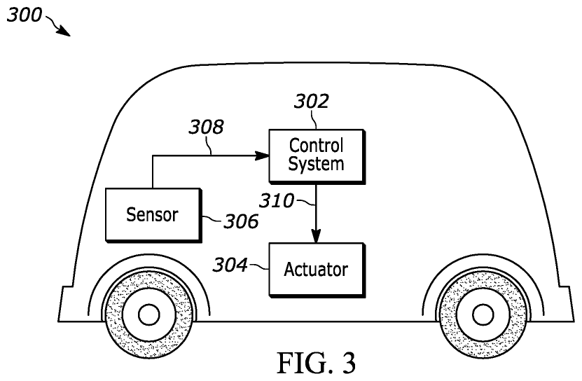

FIG. 3 depicts a schematic diagram of control system 302 configured to control vehicle 300, which may be a partially autonomous vehicle or fully autonomous vehicle, partially autonomous robot or fully autonomous robot. The vehicle 300 and/or its control system 302 can incorporate one or more components of the system 200, such as computing system 202 in order to command an actuator 304 to perform a certain action based upon processing readings from one or more sensors 306. For example, control system 302 can be configured to utilize the planning model disclosed herein in order to control movement of the vehicle via actuator 304, with the planning model being trained via the optimizer.

The one or more sensors 306 may include one or more image sensors (e.g., camera, video sensors, radar sensors, ultrasonic sensors, LiDAR sensors), and/or position sensors (e.g. GPS). The sensors 306 can be configured to generate raw source data 216 indicative of the current state and/or environment associated with the vehicle. One or more of the one or more specific sensors may be integrated into vehicle 300. In the context of agent recognition and processing as described herein, the sensor 306 is a camera mounted to or integrated into the vehicle 300. Alternatively or in addition to one or more specific sensors identified above, sensor 306 may include a software module configured to, upon execution, determine a state of actuator 304. The data generated from these sensors can be fused or otherwise combined to create a bird-eye-view (BEV) that provides spatiotemporal information associated with the vehicle and the detected agents in the environment.

In embodiments where vehicle 300 is a fully or partially autonomous vehicle, actuator 304 may be embodied in a brake, an accelerator, a propulsion system, an engine, a drivetrain, or a steering system (e.g., steering wheel) of vehicle 300. Actuator control commands may be determined such that actuator 304 is controlled such that vehicle 300 avoids collisions with detected agents, for example. Detected agents may also be classified according to what classifier deems them most likely to be, such as pedestrians or trees. The actuator control commands may be determined depending on the classification.

In other embodiments where vehicle 300 is a fully or partially autonomous robot, vehicle 300 may be a mobile robot that is configured to carry out one or more functions, such as flying, swimming, diving and stepping, via actuator 304. The mobile robot may be an at least partially autonomous lawn mower or an at least partially autonomous cleaning robot. In such embodiments, the actuator control command may be determined such that a propulsion unit, steering unit and/or brake unit of the mobile robot may be controlled such that the mobile robot may avoid collisions with identified objects.

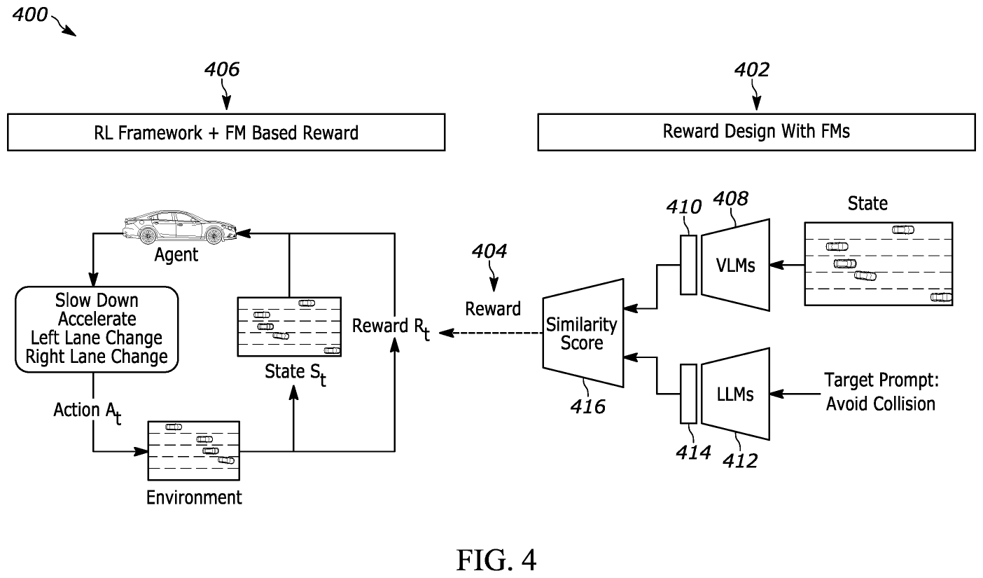

As presented above, this disclosure is directed to using foundation models for the reward function definition process in autonomous driving. In embodiments, a foundation model augmented goal-oriented reinforcement learning (RL) structure is disclosed herein for closed-loop autonomous driving tasks. FIG. 4 illustrates a schematic overview of a foundation model augmented goal-orientated reinforcement learning system 400, according to an embodiment. The system 400 includes two main sections: a reward sub-system 402 that outputs a reward 404 based on foundation models, and a reinforcement learning (RL) subsystem 406 that executes RL for training the autonomous controls of the vehicle based on the reward 404 output by the foundation model 402.

In general, and as will be discussed in greater detail herein, the current state of the vehicle is determined, for example via sensor(s) 306 and associated processor(s) and software. An associate image is produced by the sensor(s) 306 representing the image. The determined state is used as input to one or more vision language models (VLMs) 408, wherein an image-based encoder 410 associated with the VLM is configured to produce image-based embeddings of the current state of the autonomous vehicle. Meanwhile, a text prompt involving a particular goal is provided to a large language model (LLM) 412, wherein a text-based encoder 414 associated with the LLM is configured to produce text-based embeddings associated with the goal. Of note, as will be explained below, in embodiments the goal is a negative goal (e.g., “collision”) since it is easier to designate and is more objective than a positive goal (“avoid collisions”). These embeddings can be vectorized such each encoder 410, 414 generates an associated vector representing the generated image in a learned embedding space and the A foundation model is configured to derive a similarity score 416, e.g., on a scale between 0 and 1. This similarity score is then used as the reward 414 in a RL system 406 that rewards actions taken by the agent (e.g., autonomous vehicle 300) based on the state and environment.

Goal-oriented reinforcement learning represents RL algorithms that enable an agent (e.g., autonomous vehicle) to learn an optimal action policy through the rewards to achieve the specified goal. In the foundation model augmented goal-oriented reinforcement learning structure disclosed herein, the reward function is defined as the function that quantifies the similarity between the agent's current state and the goal. The augmented foundation model encodes the agent's current state and the goal so that a cosine similarity between them can be calculated and treated as the reward value. In such a way, the agent can get a stepwise reward guiding it towards the goal state, which further facilitates the reinforcement learning process compared to the sparse reward settings where the agent only gets single feedback at the end of one trial.

In autonomous driving scenarios, while the agent's current state can be easily represented by its sensory inputs, such as the images captured by its onboard camera, and text description, it is difficult to specify the goal state directly. Specifically, a goal for autonomous driving is to drive safely, which is an abstract state. Grounding such an abstract concept to a detailed state representation, for example, an image or a linguistic description describing desired driving speed and car following distance etc., requires non-trivial hand-engineering efforts, which makes it impractical and ungeneralizable across different scenarios and tasks. On the contrary, it is much easier to describe an unwanted state simply by using texts, such as, “ego car crashes”. This linguistic opposite goal is specified to the agent, and defines a negative similarity reward for the agent to stay away from the opposite goal instead of motivating the agent to reach the goal.

Given the agent state and goal descriptions, the reward function r can be determined as follows:

$$r = 1 - \frac{{FM}_{state} ( state description ) \cdot {FM}_{goal} ( goal description )}{\vert {FM}_{goal} ( goal description ) \vert \cdot \vert {FM}_{state} ( state description ) \vert} \qquad ( 1 )$$

where FMₛₜₐₜₑ and FM_{goal} represent the foundation model encoders 410, 414 for the current state and the goal state, respectively.

To implement the reward function r in Equation (1) above, three different approaches are disclosed herein: text-to-image embeddings (such as illustrated in FIG. 4 and described above), image-to-image embeddings, and text-to-text embeddings.

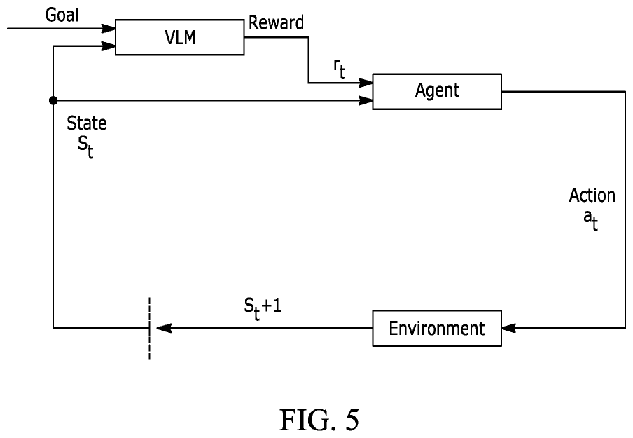

For the text-to-image embedding implementation, text is leveraged to describe the goal state (e.g., “do not hit another vehicle”), and images generated by the on-board vehicle cameras are used to represent the current state of the agent. An example of a pipeline for this implementation is shown in FIG. 5. In particular, a CLIP image encoder and CLIP text encoder are adopted to derive the embeddings of the image-based agent's current state and the text-based (opposite) goal state respectively. Then, the cosine distance between the two embeddings is determined as follows:

$$r = 1 - \frac{{CLIP}_{L} ( goal ) \cdot {CLIP}_{I} ( state )}{\vert {CLIP}_{L} ( goal ) \vert \cdot \vert {CLIP}_{I} ( state ) \vert} \qquad ( 2 )$$

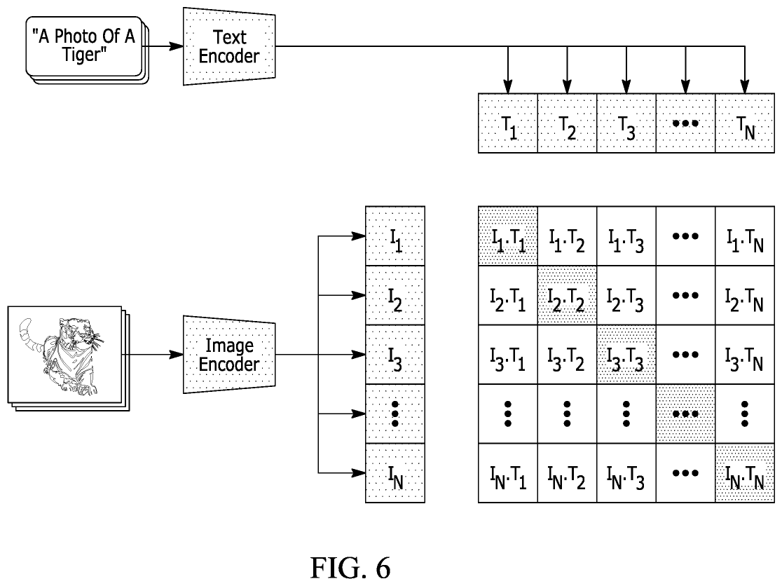

Reference to “CLIP” are to a Contrastive Language Image Pretraining (CLIP) model. CLIP was developed by OpenAI. It is designed to understand and connect images and natural language descriptions in a way that allows it to perform a wide range of vision and language tasks. The contrastive learning concept used in CLIP is shown in FIG. 6. CLIP employs a dual-encoder architecture, comprising a vision encoder and a text encoder, and a shared embedding space. The vision encoder processes images, while the text encoder processes natural language descriptions. The vision encoder, based on a vision model like a convolutional neural network (CNN), converts images into a fixed-length vector representation. The text encoder processes textual descriptions by converting them into a fixed-length vector representation. CLIP is a vision-language foundation model trained on open world data using contrastive learning. Contrastive learning is a type of machine learning where the model learns to distinguish between positive and negative pairs of data. In the context of CLIP, the “positive pair” consists of an image and a text description that are semantically related, while the “negative pair” consists of an image and a randomly selected text description that is not related. During training, CLIP is designed to encourage bringing together features from related text and images pairs into a common embedding space, while pushing unrelated pairs apart. While contrastive learning is not used to derive the similarity score r in that dissimilar features are not pushed apart, nonetheless the concept of using encoders to transform the image data and natural language into a shared embedding space for a similarity analysis is used herein.

Referring to the example embodied in FIG. 6, a plurality of images (one of which being an image of a tiger in this example) are fed into an image encoder, and a plurality of text phrases (one of which being something like “a photo of a tiger” in this example) is fed into a text encoder. In CLIP, several irrelevant or dissimilar text phrases and images are also fed into the encoders for contrastive learning, although this is not required in the current disclosure. The image encoder produces an image vector having features I₁, I₂, . . . , I_{N} while the text encoder produces a text vector having features T₁, T₂, . . . , T_{N}. The diagonal of the resulting matrix from this dot product shows paired image and text according to their likely similarity, while the off-diagonal represent unpaired image and text features.

Likewise, according to the embodiments of the present disclosure, images representing the current state are fed into a text-based encoder 410, and a text-based prompt representing a goal state (e.g., stated in a negative-goal format) is fed into a text-based encoder 414. The image encoder produces an image vector having features I₁, I₂, . . . , I_{N} while the text encoder produces a vector having language-based features L₁, L₂, . . . , L_{N}. Then, the cosine distance between the two embeddings is determined according to equation (2) above where CLIP_{I} and CLIP_{T} refer to the embeddings as determined by the image-based encoder and the text-based encoder, respectively.

This cosine distance is then used as the reward Rt for a reinforcement learning model. Referring back to FIG. 5, illustrating a high-level overview of the role of a vision-language model (VLM) in a reinforcement learning pipeline. The goal as expressed in natural language, as well as the current state as expressed by way of image data, are input into the foundation models, and a similarity between the vector-based embeddings is derived and utilized as a reward in reinforcement learning. In particular, the reward rₜ and the current state St are utilized by the agent to perform a new action aₜ. With the action being taken, the environment is determined via the vehicle's sensors, and a new state sₜ₊₁ is determined after the action is performed, which is again used by the VLM to determine a new reward. The cycle continues and the vehicle learns more and more about which actions lead to greater rewards (e.g., pushing r closer to 1 and away from 0 when on a 0 to 1 scale).

In other embodiments, image-to-image embeddings are used instead of text-to-image embeddings. For image-to-image embedding implementations, the goal state is represented as an image rather than a natural language text. A difference between this approach and the text-to-image embeddings is that here two image encoders are leveraged (e.g., from the CLIP model) and used to derive the embeddings for the similarity calculations.

In some cases, it is difficult to capture the differences among the agent's various states through only images. For example, the vehicles velocity might be very different in two similar images. Therefore, in other embodiments, text-to-text embeddings are used instead of image-to-image embeddings or text-to-image embeddings. Here, the system uses generated linguistic descriptions of the images as the agent's states. For some scenarios, the system can use template-based linguistic descriptions describing the detailed information about the surrounding vehicles, including the positions, velocity and time to collision, etc. For more complex scenarios, the system can use large vision-language models (LLM) to generate free-form descriptions of the images. The system can further use large language foundation models (e.g., SentenceBERT) to encode the text-based state description and the goal description. The cosine similarity of the two encodings is calculated and Equation (1) above is adopted to define the reward function.

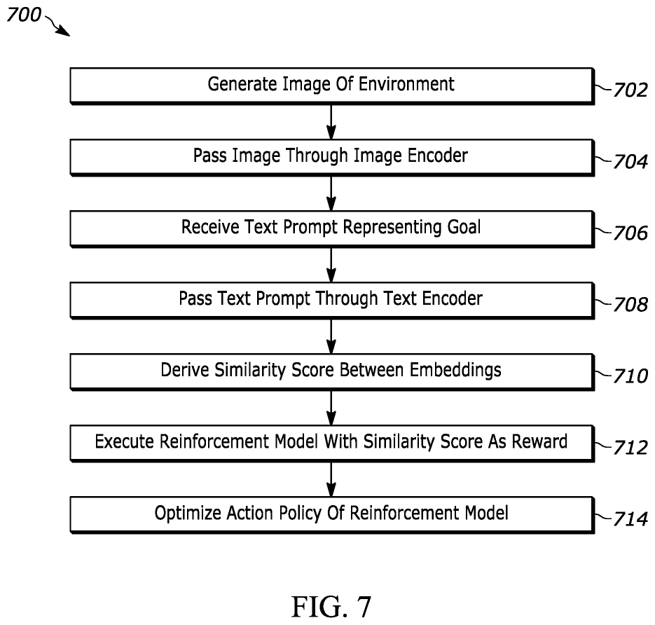

FIG. 7 illustrates a method 700 for optimizing an action policy of a machine learning model of an autonomous vehicle, according to an embodiment. The method can be executed by one or more computing systems and processors disclosed herein, such as system 100, system 200, computing system 202, etc.

At 702, one or more images of an environment about a vehicle is generated. The images are generated based on vehicle sensors and/or the accompanying data generated by this sensors, such as sensors 306, e.g., cameras. The images can include pedestrians, other vehicles, lane lines, traffic signals, and the like. These images and/or the accompanying data depicts or represents a current state of the autonomous vehicle.

At 704, these images are passed through (executed by) an image encoder to generate image-based embeddings of the current state of the autonomous vehicle. The image encoder can be from a CLIP model, for example, in which a vector is generated having features I₁, I₂, . . . , I_{N}, for example.

At 706, a text prompt is generated and received, wherein the text prompt represents a goal (or inverse goal) of the autonomous vehicle. For example, the goal can be “collision with another vehicle” or “drive over the speed limit” or the like. At 708, these text prompts are passed through (executed by) a text encoder to generate text-based embeddings of the goal. The text encoder can be from a CLIP model, for example, in which a text vector is generated having features T₁, T₂, . . . , T_{N}. As explained above, the “goal” used may actually be an inverse goal, because some goal are easier to process objectively if they are in the negative form than in the positive form. For example, “do not collide with a vehicle” can be ambiguous, because there are infinite spaces in which the vehicle can exist without colliding with another vehicle. A goal may therefore be “collide with a vehicle” which can be easily determined, and the inverse of this goal can be used during the determination of the reward (e.g., see equation (1) above).

At 710, a similarity score is determined. The similarity score represents a similarity between the image-based embeddings of the current state and the text-based embeddings of the goal. For example, using equation (1) above can derive a similarity score which can be used as a reward, r, in a reinforcement learning model. Cosine similarity can be used for determination of the similarity score. In some embodiments, a dot product function can measure the similarities between the two vectors.

At 712, a reinforcement learning model is executed for a closed-loop autonomous driving task (e.g., highway driving, parking, urban driving, etc.). Here, the determined similarity score from 710 is used as the reward in a reinforcement learning model loop, such as shown and described in FIGS. 4-5 above. At 714, an action policy of the reinforcement learning model is optimized based on iterations of the reinforcement learning model using the similarity scores as the rewards during iterations. The action policy is associated with a control command of the autonomous vehicle, such as steering, acceleration, braking, lane change, and the like. The reinforcement learning policy is optimized through iterations when the reward is greater and greater, e.g., closer to 1 than 0 when on a 0 to 1 scale.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for optimizing an action policy of a machine learning model of an autonomous vehicle, the method comprising:
generating an image of an environment about an autonomous vehicle based on vehicle sensor data representing a current state of the autonomous vehicle;
passing the generated image through an image encoder to generate image-based embeddings of the current state of the autonomous vehicle;
receiving a text prompt representing a goal of the autonomous vehicle;
passing the text prompt through a text encoder to generate text-based embeddings of the goal;
determining a similarity score representing a similarity between the image-based embeddings of the current state and the text-based embeddings of the goal;
executing a reinforcement learning model for a closed-loop autonomous driving task, wherein the similarity score is utilized as a reward in the reinforcement learning model; and
optimizing an action policy of the reinforcement learning model based on the similarity score utilized as the reward, wherein the action policy is associated with a control command of the autonomous vehicle.

2. The method of claim 1, further comprising:
executing a foundation model to perform the determining of the similarity score.

3. The method of claim 2, wherein the similarity score is determined as follows:
$$r = 1 - \frac{{FM}_{state} ( state description ) \cdot {FM}_{goal} ( goal description )}{\vert {FM}_{goal} ( goal description ) \vert \cdot \vert {FM}_{state} ( state description ) \vert}$$
wherein r represents the reward utilized in the reinforcement learning model, FMₛₜₐₜₑ represents the image-based embeddings of the current state of the autonomous vehicle, and FM_{goal} represents the text-based embeddings of the goal.

4. The method of claim 1, wherein the text prompt is a human-crafted text prompt not generated by a machine learning model.

5. The method of claim 1, wherein the determining of the similarity score includes deriving an inverse of the similarity between the image-based embeddings of the current state and the text-based embeddings of the goal.

6. The method of claim 1, wherein the image encoder is part of a vision-language model (VLM) configured to generate a vector representing the generated image in a learned embedding space.

7. The method of claim 6, wherein the text encoder is part of a large language model (LLM) configured to generate a vector representing the goal in a learned embedding space.

8. A system for optimizing an action policy of a machine learning model of an autonomous vehicle, the system comprising:
one or more image sensors mounted to an autonomous vehicle and configured to generate images external to the autonomous vehicle representing a current state of the autonomous vehicle; and
one or more processors communicatively coupled to the one or more images sensors, the one or more processors programmed to:
receive the generated images from the one or more image sensors,
execute an image encoder on the generated images to generate image-based embeddings of the current state of the vehicle,
receive a text prompt representing a goal of the autonomous vehicle,
execute a text encoder on the text prompt to generate text-based embeddings of the goal,
determine a similarity score representing a similarity between the image-based embeddings of the current state and the text-based embeddings of the goal,
execute a reinforcement learning model for a closed-loop autonomous driving task, wherein the similarity score is utilized as a reward in the reinforcement learning model, and
optimize an action policy of the reinforcement learning model based on the similarity score utilized as the reward, wherein the action policy is associated with a control command of the autonomous vehicle.

9. The system of claim 8, wherein the one or more processors are further programmed to:
execute a foundation model to perform the determining of the similarity score.

10. The system of claim 9, wherein the similarity score is determined as follows:
$$r = 1 - \frac{{FM}_{state} ( state description ) \cdot {FM}_{goal} ( goal description )}{\vert {FM}_{goal} ( goal description ) \vert \cdot \vert {FM}_{state} ( state description ) \vert}$$
wherein r represents the reward utilized in the reinforcement learning model, FMₛₜₐₜₑ represents the image-based embeddings of the current state of the autonomous vehicle, and FM_{goal} represents the text-based embeddings of the goal.

11. The system of claim 8, wherein the text prompt is a human-crafted text prompt not generated by a machine learning model.

12. The system of claim 8, wherein the determination of the similarity score includes deriving an inverse of the similarity between the image-based embeddings of the current state and the text-based embeddings of the goal.

13. The system of claim 8, wherein the image encoder is part of a vision-language model (VLM) configured to generate a vector representing the generated image in a learned embedding space.

14. The system of claim 13, wherein the text encoder is part of a large language model (LLM) configured to generate a vector representing the goal in a learned embedding space.

15. A non-volatile computer-readable storage medium storing instructions that, when executed by one or more processor, cause the one or more processor to perform actions comprising:
generating an image of an environment about an autonomous vehicle based on vehicle sensor data representing a current state of the autonomous vehicle;
passing the generated image through an image encoder to generate image-based embeddings of the current state of the autonomous vehicle;
receiving a text prompt representing a goal of the autonomous vehicle;
passing the text prompt through a text encoder to generate text-based embeddings of the goal;
determining a similarity score representing a similarity between the image-based embeddings of the current state and the text-based embeddings of the goal;
executing a reinforcement learning model for a closed-loop autonomous driving task, wherein the similarity score is utilized as a reward in the reinforcement learning model; and
optimizing an action policy of the reinforcement learning model based on the similarity score utilized as the reward, wherein the action policy is associated with a control command of the autonomous vehicle.

16. The non-volatile computer-readable storage medium of claim 15, wherein the instructions, when executed by the one or more processor, cause the one or more processor to perform further actions comprising:
executing a foundation model to perform the determining of the similarity score.

17. The non-volatile computer-readable storage medium of claim 16, wherein the similarity score is determined as follows:
$$r = 1 - \frac{{FM}_{state} ( state description ) \cdot {FM}_{goal} ( goal description )}{\vert {FM}_{goal} ( goal description ) \vert \cdot \vert {FM}_{state} ( state description ) \vert}$$
wherein r represents the reward utilized in the reinforcement learning model, FMₛₜₐₜₑ represents the image-based embeddings of the current state of the autonomous vehicle, and FM_{goal} represents the text-based embeddings of the goal.

18. The non-volatile computer-readable storage medium of claim 15, wherein the text prompt is a human-crafted text prompt not generated by a machine learning model.

19. The non-volatile computer-readable storage medium of claim 15, wherein the determining of the similarity score includes deriving an inverse of the similarity between the image-based embeddings of the current state and the text-based embeddings of the goal.

20. The non-volatile computer-readable storage medium of claim 15, wherein the image encoder is part of a vision-language model (VLM) configured to generate a vector representing the generated image in a learned embedding space.
